(19) United States
(12) Patent Application Publication
(10) Pub. No.: US 2014/0103230 A1
(43) Pub. Date: Apr. 17, 2014

(54) RADIOACTIVE RAY SHIELD OR ABSORPTION SHEET WITH FLEXIBILITY AND RESTORABILITY, CLOTHES MADE OF THE SAME, AND MANUFACTURING METHOD THEREOF

(71) Applicant: Dal Hoon KANG, Incheon (KR)

(72) Inventor: Woo Seok KANG, Incheon (KR)

(73) Assignees: Dal Hoon KANG, Incheon (KR); Woo Seok KANG, Incheon (KR)

(21) Appl. No.: 13/651,236

(22) Filed: Oct. 12, 2012

(51) Int. Cl. G21F 1/08; G21F 3/02

(52) U.S. Cl. CPC G21F 1/085; G21F 3/02
USPC 250/516.1; 252/478; 264/128

(57) ABSTRACT

Disclosed are a radioactive ray shield sheet with flexibility and restoration, clothes made of the same and a manufacturing method thereof, the radioactive shield sheet manufactured to have a sheet shape by mixing powdered lead with an additive compound, and having flexibility and restorability. Thus, there is provided a radioactive ray shield sheet which is flexible and restorable, convenient to use, and improved in safety.

### BACKGROUND

1. Field of Invention

Apparatuses and methods consistent with exemplary embodiments relate to a radioactive ray shield sheet with flexibility and restoration, clothes made of the same and a manufacturing method thereof, and more particularly to a radioactive ray shield sheet with flexibility and restorability, which is shaped like a sheet, and is capable of blocking out a gamma radioactive ray, clothes made of the same and a manufacturing method thereof.

2. Description of the Related Art

Nuclei of uranium, plutonium and the like element having a very high atomic weight are so heavy and unstable that they decay naturally. When such elements decay into another element, some particles and electromagnetic waves are emitted. These are called radioactive rays. The element that emits the radioactive rays is called a radioactive element, and such capability of emitting the radioactive rays is called radioactivity. The radioactive rays emitted when such an element decays includes three, i.e., an α (alpha) ray, a β (beta) ray and a γ (gamma) ray. However, the general meaning of the radioactive rays often includes not only these three rays but also other particles or electromagnetic waves such as X-rays, neutron rays, etc. The radioactive rays are broadly classified into two, i.e., corpuscular rays of moving particles such as the α(alpha) ray, the β(beta) ray and the neutron ray, and the electromagnetic wave such as the X-ray and the γ(gamma) ray. Hereinafter, the γ(gamma) ray and the neutron ray between the classified two rays will be representatively examined.

The γ(gamma) ray is an electromagnetic wave having a very short wavelength, i.e., light. The electromagnetic waves having a wavelength shorter than 10 pm(10-9 m) is generally called the gamma rays. The gamma ray and the X-ray have an overlapped wavelength region and similar properties, and therefore they are typically distinguished from each other based on not the wavelength but cause of generation. The gamma ray refers to an electromagnetic wave based on energy released when one element is changed into another element due to nuclear decay, and the X-ray refers to an electromagnetic wave based on energy released not from the nucleus but from an electron in an atom. When the alpha or beta rays are emitted as the nucleus in the atom, mass fractionally decreases. The mass decrease is converted into high energy based on E=mc². This energy makes an atomic nucleus unstable, and thus electromagnetic waves are generated with high energy when the unstable atomic nucleus returns to a stable state.

The electromagnetic waves with higher energy have a shorter wavelength. Therefore, the gamma rays are emitted when the atomic nucleus decays. Although the gamma ray itself has no ionization power, the energy of the gamma ray is so high that atoms or molecules of a substance are affected to be ionized. This phenomenon causes the photoelectric effect or the Compton effect. Also, the gamma ray produces an electron and a positron while decaying (pair production). On the contrary, the electron and the positron annihilate to become the gamma ray (pair annihilation). The gamma ray has weaker ionization power than alpha the alpha ray and the beta ray, but has very strong penetrating power. Thus, the gamma ray generally causes danger of radiation exposure. A substance, which has high density like concrete, iron and lead, can intercept the gamma ray. However, although the best-interceptor, i.e., lead is used, it needs a thickness of about 10 cm.

As a representative particle beam, there are neutron rays, proton rays, cosmic rays, etc. Among the electromagnetic waves, an ultraviolet ray does not belong to the radioactive rays even though it brings the ionization. The X-ray is an electromagnetic wave having a wavelength of 10⁻⁹m to 10⁻⁵m, which has weaker than the gamma ray as is generally longer than the wavelength of the gamma ray. The proton ray and the neutron ray are produced by not the nuclear decay but an artificial means such as an atomic reactor or a particle accelerator. The proton ray is similar to the alpha ray. The neutron ray has no electric charge, but its kinetic energy is so high that the ionization can occur by emitting the gamma rays or producing the protons while losing the kinetic energy. The cosmic ray refers to all radioactive rays produced from the universe except the earth, such as the atomic nucleus or the atomic reactor, which includes muons, neutrinos, electrons, neutrons, gamma rays, etc.

In real life, such a radioactive ray may be emitted in a nuclear power plant, an institute of atomic energy, a hospital, etc., where the radioactive rays are treated. To shield a worker, who works under a condition that the radioactive rays are emitted, from the radiation exposure, a radioactive ray shield sheet made of a shielding substance has been used. However, such a shield sheet is inconvenient for a user since it is not bent or restored after being bent. Also, as a typical substance for shielding the radioactive rays, lead is made in the form of an ingot. Many ingots are seamed together, and therefore stability may be lowered due to a seam for connecting the ingots and a hole for forming the seam.

### SUMMARY

An exemplary embodiment may provide a radioactive ray shield or absorption sheet excellent in flexible and restorable properties, clothes made of the same and a manufacturing method thereof.

Another exemplary embodiment may provide a radioactive ray shield or absorption sheet improved in safety, clothes made of the same and a manufacturing method thereof.

Still another exemplary embodiment may provide a radioactive ray shield or absorption sheet, which is free from poisoning because lead powder, boron powder or tungsten powder is not friable and does not fall, clothes made of the same and a manufacturing method thereof.

Still another exemplary embodiment may provide a radioactive ray shield or absorption sheet enhanced in a range of applications, clothes made of the same and a manufacturing method thereof.

Still another exemplary embodiment may provide a radioactive ray shield or absorption sheet, easily wearable clothes made of the same and a manufacturing method thereof.

Still another exemplary embodiment may provide a radioactive ray shield or absorption sheet improved in a range of applications, clothes made of the same and a manufacturing method thereof.

According to an aspect of an exemplary embodiment, a radioactive shield sheet is manufactured to have a sheet shape by mixing powdered lead with an additive compound, and has flexibility and restorability.

According to an aspect of an exemplary embodiment, a method of manufacturing a radioactive shield sheet and radioactive shield clothes includes: mixing powdered lead and a compound; and molding the mixture at high pressure to have a sheet shape with high density.

According to an aspect of an exemplary embodiment, a neutron radioactive absorption sheet is manufactured to have a sheet shape by mixing powdered boron carbide with an additive compound, and has flexibility and restorability.

According to an aspect of an exemplary embodiment, a tungsten sheet is manufactured to have a sheet shape by mixing powdered tungsten with an additive compound, and has flexibility and restorability.

### BRIEF DESCRIPTION OF THE DRAWINGS

The above and/or other aspects of the present invention will become apparent and more readily appreciated from the following description of the exemplary embodiments, taken in conjunction with the accompanying drawings, in which:

FIGS. 1(a) to 1(d) are schematic views for explaining a process of manufacturing a substance for a radioactive ray shield sheet according to an exemplary embodiment;

FIG. 1(e) is a sectional view of the substance for the radioactive ray shield sheet according to an exemplary embodiment;

FIG. 1(f) shows clothes made of the radioactive ray shield sheet according to an exemplary embodiment;

FIG. 2 is a flowchart of manufacturing the radioactive ray shield sheet according to an exemplary embodiment; and

FIG. 3 is a sectional view of the substance for the radioactive ray shield sheet according to another exemplary embodiment.

### DETAILED DESCRIPTION OF EXEMPLARY EMBODIMENTS OF THE INVENTION

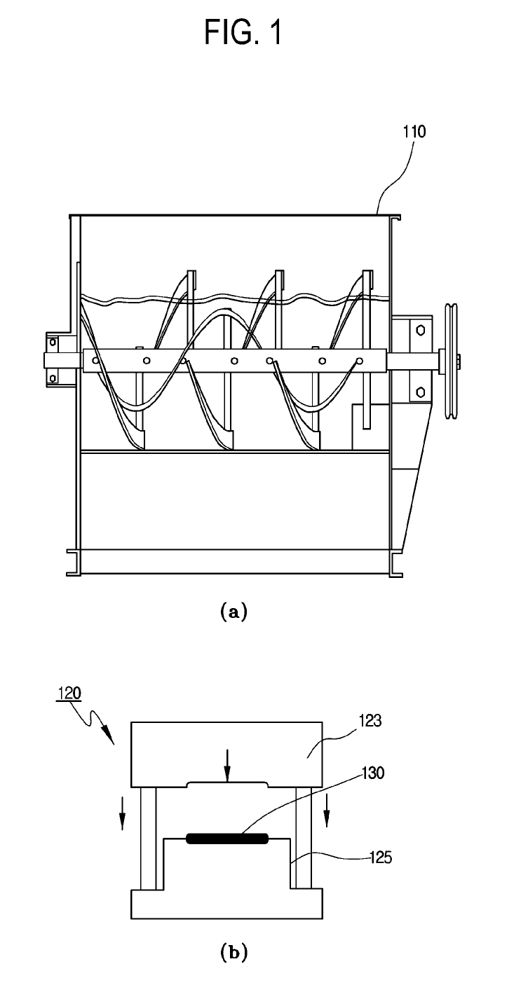

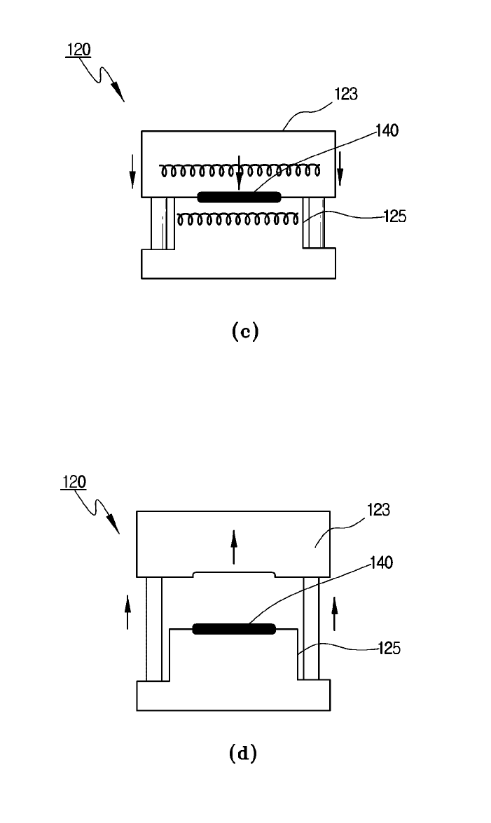

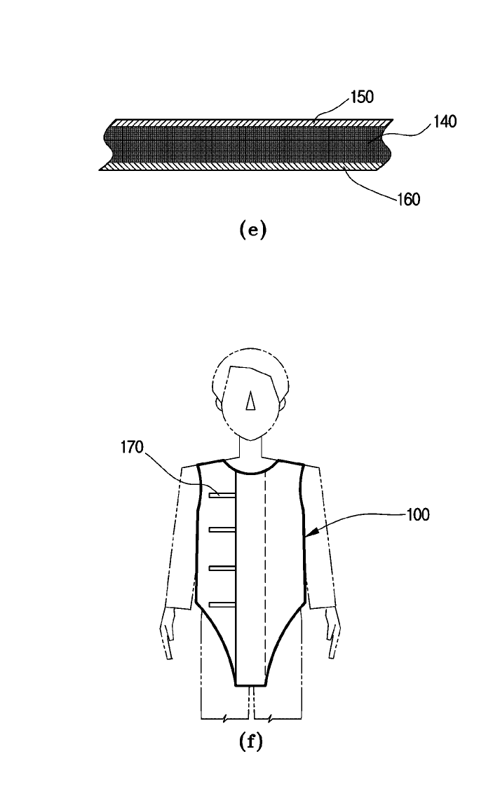

Below, embodiments will be described in detail with reference to FIGS. 1(a) to 3.

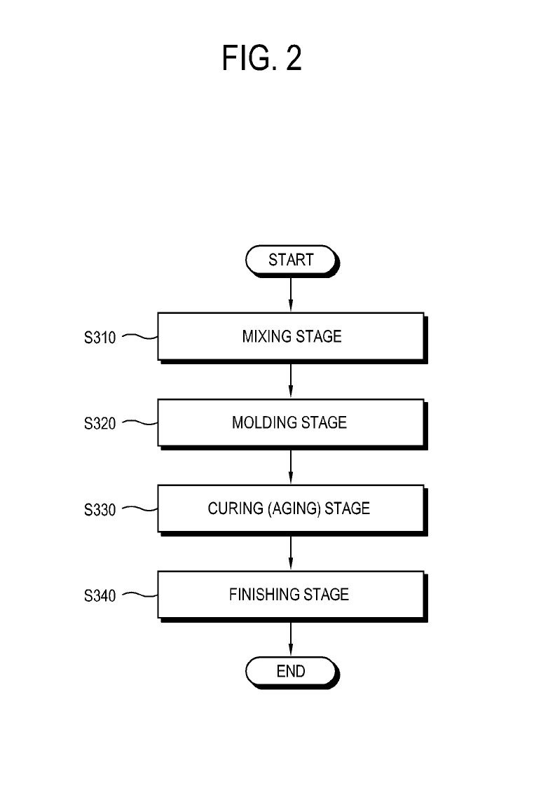

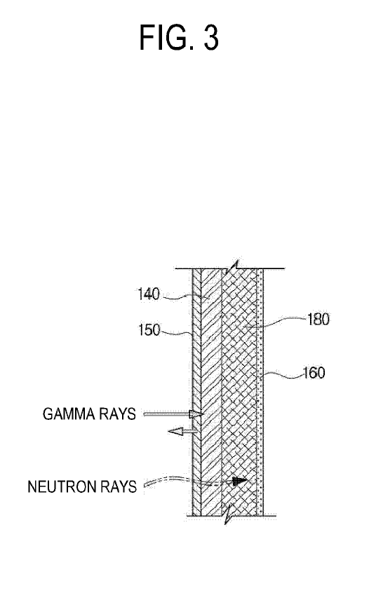

FIGS. 1(a) to 1(d) are schematic views for explaining a process of manufacturing a substance for a radioactive ray shield sheet according to an exemplary embodiment, FIG. 1(e) is a sectional view of the substance for the radioactive ray shield sheet according to an exemplary embodiment, FIG. 1(f) shows clothes made of the radioactive ray shield sheet according to an exemplary embodiment, FIG. 2 is a flowchart of manufacturing the radioactive ray shield sheet according to an exemplary embodiment, and FIG. 3 is a sectional view of the substance for the radioactive ray shield sheet according to another exemplary embodiment.

### First Embodiment

In particular, a radioactive ray shield sheet 100 according to the first embodiment mainly serves to shield a gamma ray to an X-ray, which has directionality, among the foregoing kinds of radioactive rays.

In a mixing stage S310, as shown in FIGS. 1(a) to 2, a main substance, i.e., powdered lead and a sub substance are mixed by a mixing means 110 such as a mixer or the like, thereby preparing a mixed substance. At this time, the mixing means 110 may include various kinds of mixing units such as the mixer. Meanwhile lead is used in the form of powder, and therefore the mixing means 110 may have a sealed structure so as to prevent poisonous dust from scattering. In this exemplary embodiment, the content of powdered lead may be equal to or higher than 95 wt %. If the content of powdered lead is lower than 95 wt %, a function of shielding the radioactive rays becomes inferior. Alternatively, the content of powdered lead may range from 80 wt % to 95 wt %. In the following, a shielding rate of shielding the gamma rays among the radioactive rays is varied depending on a mixing ratio of powdered lead, i.e., depending on the thickness of a substance 140 shaped like a plate. That is, the substance 140 containing powdered lead of 80 wt % and the substance 140 containing powdered lead of 95 wt % are different in the shielding rate even though they have the same thickness. In the case of the same content of powdered lead, a shielding rate for the gamma radioactive rays becomes higher as the thickness and density of the substance 140 increase. Lead is a substance for shielding the gamma rays having the directionality. In this exemplary embodiment, lead is used in the form of powder. Further, powdered lead may have high purity for a high shielding rate.

A substance added to powdered lead includes an ester high molecular compound of an isocyanate group. Further, an additive for combining the substance and powdered lead each other is added. Thus, the radioactive ray shield sheet 100 according to an exemplary embodiment makes particles of powdered lead be strongly bonded and be highly densified. Through a lot of experiments, the ester high molecular compound of the isocyanate group was proved to achieve the strong bond and high density of powdered lead, among various compounds. Like most cases, the physical properties and the like of the radioactive ray shield sheet 100 finally manufactured are varied depending on the kinds of additive compounds.

In a molding stage S320, as shown in FIGS. 1(b), 1(c) and 2, a press work is performed with a die having an upper mold 123 and a lower mold 125 by way of example. For instance, a mixed raw substance 130 is put on the lower mold 125 placed in a lower portion of a press 120, and the upper mold 123 placed in an upper portion of the press 120 moves down to press the mixed raw substance 130 against the lower mold 125. At this time, the raw substance 130 and a substance 140 may keep a temperature, e.g., at 45±5° C. If the temperature is beyond this range, it is somewhat difficult to perform the molding. To keep this temperature, a heater (not shown) may be provided in the upper mold 123 or the lower mold 125.

In an aging (curing) stage S330, as shown in FIGS. 1(c) and 2, the mixed substance 140 is kept pressed for a predetermined time at a certain temperature, and thus aged. The aging stage is needed for securing the stability of the product. For example, a product having a thickness of 2 mm is kept for about 10±1 hours at a room temperature of 20±5° C., but not limited thereto. Alternatively, the time and the temperature may be varied depending on the desired thickness of the product. Although the aging is performed for a longer time than the foregoing time, there is no improvement in effect from the aging. If the aging is performed for a shorter time than the foregoing time, powdered lead and the compound are not strongly bonded and highly densified and thus lead in the product is likely to be crumbled or lead is likely to fall out of the product.

As the time in this stage elapses, the substance 140 is also cured. That is, this stage is needed for stabilization based on chemical reaction among powdered lead, the high molecular compound, the additives, and the like. The substance 140 passed through this stage becomes a highly dense substance 140 shaped like a plate.

The substance 140 formed as above has flexibility and restorability superior to the existing substance for shielding the radioactive rays.

According to an exemplary embodiment, if the content of powdered lead, the thickness of the product, etc. are different, different time and different temperature may be applied to the foregoing embodiments.

In a finishing stage S340, as shown in FIGS. 1(d) to 2, there are processes of finishing the substance 140 separated from the upper mold 123 and the lower mold 125, attaching an outer layer or an inner layer, sewing cloth corresponding to a design of clothes, and making the clothes.

First, as shown in FIG. 1(d), the upper mold 123 is separated from the lower mold 125, and the substance 140 is separated from the lower mold 125. Although it is not shown, finishing process such as a process for clearly trimming edges of the substance 140 separated from the upper mold 123 and the lower mold 125, or the like work is performed.

Next, as shown in FIG. 1(e), the inner layer 160 or the outer layer 150 is attached to the inside or the outside of the substance 140 by an adhesive. In this process, the high molecular compound of the isocyanate group contained in the substance 140 may be used as an adhesive for attaching the inner layer 160 or the outer layer 150 to the substance 140. Thus, an ingredient contained in the substance 140 is also employed as the adhesive, thereby more enhancing adhesion.

Then, as shown in FIG. 1(f), the substance 140 is cut in a pattern of a jacket that a user can easily wear, thereby making radioactive ray shield clothes with a required shape. Meanwhile, the Velcro tape may be used as a coupling means for coupling a front opened without any seam, any hole or the like since the substrate 140 shaped like a plate is used. Accordingly, it is possible to remove the conventional seam, hole or the like portions where shield is not performed, and thus to more efficiently shield the radioactive rays.

That is, it is very convenient for a user to use the radioactive shield clothes 100 since s/he wears the radioactive shield clothes 100 made of the radioactive ray shield sheet 140 according to an embodiment like a typical jacket opened frontward and then shuts it up using the

Velcro tape 170. Further, the radioactive shield clothes 100 is improved in stability because it is made in the form of a single plate without any seam, any hole or the like

In the foregoing exemplary embodiments, the radioactive ray shield sheet 100 is applied to only the clothes, but not limited thereto. Alternatively, the radioactive ray shield sheet 100 may be very effective when it is applied to not only the clothes but also a shield curtain in a radiation room where the radioactive rays are emitted, a protective wall, etc. For example, the radioactive ray shield sheet 100 can very effectively shield the radioactive rays even when it is applied to a wall or the like structure.

### Second Embodiment

In particular, a neutron radioactive ray absorption sheet 100 according to a second embodiment mainly serves to shield the neutron rays, which has no directionality, among the foregoing kinds of radioactive rays.

In a mixing stage S310, as shown in FIGS. 1(a) to 2, a main substance, i.e., powdered boron carbide and a sub substance are mixed by a mixing means 110 such as a mixer or the like, thereby preparing a mixed substance. At this time, the mixing means 110 may include various kinds of mixing units such as the mixer. Meanwhile, boron carbide is used in the form of powder, and therefore the mixing means 110 may have a sealed structure so as to prevent poisonous dust from scattering. In this exemplary embodiment, the content of powdered boron carbide may be within a range of 55˜60 wt %. If the content of powdered boron carbide is lower than 55 wt %, a function of shielding or absorbing the radioactive rays becomes inferior. If the content of powdered boron carbide is higher than 60 wt %, a function of shielding or absorbing the radioactive rays becomes superior, but economical efficiency has to be considered since boron carbide. Alternatively, the content of powdered boron carbide in a neutron ray absorption sheet 140 may be equal to or higher than 35 wt % but lower than 55 wt %.

In the following, a shielding or absorbing rate of shielding or absorbing the neutrons among the radioactive rays is varied depending on a mixing ratio of powdered boron carbide, i.e., depending on the thickness of a substance 140 shaped like a plate. That is, the substance 140 containing powdered boron carbide of 35 wt % and the substance 140 containing powdered boron carbide of 60 wt % are different in the shielding rate even though they have the same thickness. In the case of the same content of powdered boron carbide, a shielding or absorbing rate for the neutron radioactive rays becomes higher as the thickness and density of the substance 140 increase. Boron carbide is a substance for absorbing the neutron rays having no directionality. In this exemplary embodiment, boron carbide is used in the form of powder. Further, powdered boron carbide may have high purity for a high shielding or absorbing rate.

A substance added to powdered boron carbide includes an ester high molecular compound of an isocyanate group. Further, an additive for combining the substance and powdered boron carbide each other is added. Thus, the neutron radioactive ray shield sheet 100 according to an exemplary embodiment makes particles of powdered boron carbide be strongly bonded and be highly densified. Through a lot of experiments, the ester high molecular compound of the isocyanate group was proved to achieve the strong bond and high density of powdered boron carbide, among various compounds. Like most cases, the physical properties and the like of the neutron radioactive ray shield sheet 100 finally manufactured are varied depending on the kinds of additive compounds.

The following molding, aging (curing) and finishing stages S320, S330 and S340 are the same as those of the first embodiment, and thus repetitive descriptions thereof will be avoided.

### Third Embodiment

Below, a third embodiment will be described in detail with reference to FIGS. 1(a) to 3. In this embodiment, FIG. 1(e) is replaced by FIG. 3.

In particular, a neutron ray absorption and gamma ray shield sheet 100 according to the third embodiment mainly serves to both shield a gamma ray, which has directionality, and absorb a neutron ray, which has no directionality, among the foregoing kinds of radioactive rays.

In a mixing stage S310, as shown in FIGS. 1(a) to 2, a main substance, i.e., powdered boron carbide and a sub substance are mixed by a mixing means 110 such as a mixer or the like, thereby preparing a mixed substance. That is, this stage is to prepare the radioactive ray absorption sheet. At this time, the mixing means 110 may include various kinds of mixing units such as the mixer. Meanwhile, boron carbide is used in the form of powder, and therefore the mixing means 110 may have a sealed structure so as to prevent poisonous dust from scattering. In this exemplary embodiment, the content of powdered boron carbide may be within a range of 55˜60 wt %. If the content of powdered boron carbide is lower than 55 wt %, a function of shielding or absorbing the radioactive rays becomes inferior. If the content of powdered boron carbide is higher than 60 wt %, a function of shielding or absorbing the radioactive rays becomes superior, but economical efficiency has to be considered since boron carbide. Alternatively, the content of powdered boron carbide in a neutron absorption sheet 180 may be equal to or higher than 35 wt % but lower than 55 wt %. Below, according to contexts, the reference numeral of 140 narrowly refers to the radioactive ray shield sheet, and broadly refers to a substance including the radioactive ray absorption sheet as well as the radioactive ray shield sheet.

In the mixing stage S310, as shown in FIGS. 1(a) to 2, a main substance, i.e., powdered lead and a sub substance are mixed by the mixing means 110 such as a mixer or the like, thereby preparing a mixed substance. That is, this stage is to prepare the radioactive ray shield sheet 140. Meanwhile, lead is used in the form of powder, and therefore the mixing means 110 may have a sealed structure so as to prevent poisonous dust from scattering. In this exemplary embodiment, the content of powdered lead may be equal to or higher than 90 wt %. If the content of powdered lead is lower than 95 wt %, a function of shielding the radioactive rays becomes inferior. Alternatively, the content of powdered lead may range from 80 wt % to 95 wt %.

In the following, a shielding or absorbing rate of shielding or absorbing the gamma rays or neutron rays among the radioactive rays is varied depending on a mixing ratio of powdered lead or powdered boron carbide, i.e., depending on the thickness of a substance 140 shaped like a plate. That is, the substance 140 containing powdered boron carbide of 35 wt % and the substance 140 containing powdered boron carbide of 60 wt % are different in the shielding rate even though they have the same thickness. In the case of the same content of powdered boron carbide, a shielding or absorbing rate for the neutron radioactive rays becomes higher as the thickness and density of the substance 140 increase. Boron carbide is a substance for absorbing the neutron rays having no directionality. In this exemplary embodiment, boron carbide is used in the form of powder. Further, powdered boron carbide may have high purity for a high shielding or absorbing rate.

Likewise, the substance 140 containing powdered lead of 80 wt % and the substance 140 containing powdered lead of 95 wt % are different in the shielding rate even though they have the same thickness. In the case of the same content of powdered lead, a shielding rate for the gamma radioactive rays becomes higher as the thickness and density of the substance 140 increase. Lead is a substance for shielding the gamma rays having the directionality. In this exemplary embodiment, lead is used in the form of powder. Further, powdered lead may have high purity for a high shielding rate.

A substance added to powdered lead or powdered boron carbide includes an ester high molecular compound of an isocyanate group. Further, an additive for combining the substance and powdered boron carbide each other is added. Thus, the neutron ray absorption and gamma ray shield sheet 100 according to an exemplary embodiment makes particles of powdered boron carbide be strongly bonded and be highly densified. Through a lot of experiments, the ester high molecular compound of the isocyanate group was proved to achieve the strong bond and high density of powdered boron carbide, among various compounds. Like most cases, the physical properties and the like of the neutron ray absorption and gamma ray shield sheet 100 finally manufactured are varied depending on the kinds of additive compounds.

The following molding and curing stages S320 and S330 are equally applied to the radioactive ray shield sheet 140 and the radioactive ray absorption sheet 180. The molding and curing stages S320 and S330 are the same as those of the first embodiment, and thus repetitive descriptions thereof will be avoided.

In a finishing stage S340, as shown in FIGS. 1(f), 2 and 3, there are processes of finishing the substance 140 separated from the upper mold 123 and the lower mold 125, coupling the radioactive ray shield sheet and the radioactive ray absorption sheet, attaching an outer layer or an inner layer, sewing cloth corresponding to a design of clothes, and making a desired shape like the clothes.

First, as shown in FIG. 1(d), the upper mold 123 is separated from the lower mold 125, and the substance 140 is separated from the lower mold 125. Although it is not shown, finishing process such as a process for clearly trimming edges of the substance 140 separated from the upper mold 123 and the lower mold 125, or the like work is performed.

Next, as shown in FIG. 3, the radioactive ray shield sheet 140 and the radioactive ray absorption sheet 180 are coupled to each other. In this process, the high molecular compound of the isocyanate group contained in the raw substance for both the sheets 140 and 180 may be used as an adhesive for coupling both sheets 140 and 180. Thus, an ingredient contained in the substance 140 is also employed as the adhesive, thereby more enhancing adhesion between both the sheets 140 and 180.

Then, as shown in FIG. 3, the inner layer 160 or the outer layer 150 is attached to the inside or the outside of the substance 140 by an adhesive. In this process, the high molecular compound of the isocyanate group contained in the substance 140 may be used as an adhesive for attaching the inner layer 160 or the outer layer 150 to the substance 140. Thus, an ingredient contained in the substance 140 is also employed as the adhesive, thereby more enhancing adhesion.

### Fourth Embodiment

A tungsten sheet 100 according to the fourth embodiment mainly serves to shield a gamma ray to an X-ray, which has directionality, among the foregoing kinds of radioactive rays if it is used in the radioactive ray shield clothes.

In a mixing stage 5310, as shown in FIGS. 1(a) to 2, a main substance, i.e., powdered tungsten and highly dense metal powder containing molybdenum, and a sub substance are mixed by a mixing means 110 such as a mixer or the like, thereby preparing a mixed substance. At this time, the mixing means 110 may include various kinds of mixing units such as the mixer. Meanwhile, tungsten and highly dense metal is used in the form of powder, and therefore the mixing means 110 may have a sealed structure so as to prevent poisonous dust from scattering. In this exemplary embodiment, the content of powdered tungsten may be equal to or higher than 80˜95 wt %. If the content of powdered lead is lower than 80 wt %, a function of shielding the radioactive rays becomes inferior. Alternatively, the content of powdered lead may be lower than 80 wt %, or equal to or higher than 95 wt %. In the following, a shielding rate of shielding the gamma rays among the radioactive rays is varied depending on a mixing ratio of powdered tungsten, i.e., depending on the thickness of a substance 140 shaped like a plate. That is, the substance 140 containing powdered tungsten of 80 wt % and the substance 140 containing powdered tungsten of 95 wt % are different in the shielding rate even though they have the same thickness. In the case of the same content of powdered tungsten, a shielding rate for the gamma radioactive rays becomes higher as the thickness and density of the substance 140 increase. Tungsten is a substance for shielding the gamma rays having the directionality. In this exemplary embodiment, tungsten is used in the form of powder. Further, powdered tungsten may have high purity for a high shielding rate.

A substance added to powdered tungsten includes an ester high molecular compound of an isocyanate group. Further, an additive for combining the substance and powdered lead each other is added. Thus, the tungsten sheet 100 according to an exemplary embodiment makes particles of powdered tungsten be strongly bonded and be highly densified. Through a lot of experiments, the ester high molecular compound of the isocyanate group was proved to achieve the strong bond and high density of powdered tungsten, among various compounds. Like most cases, the physical properties and the like of the tungsten sheet 100 finally manufactured are varied depending on the kinds of additive compounds.

Besides the tungsten powder used as the main substance, powder of molybdenum, platinum or the like metal having high density may be added. These are mixed with the tungsten powder to form a more highly dense sheet. Here, the sum content of tungsten powder and metal powder may be 97˜98 wt %. A ratio of the tungsten power to the highly dense metal powder may be 95˜99%. A different kind of metal powder having high density is added to the tungsten powder so as to increase the density of the tungsten powder, but its amount may be very tiny.

The following molding, aging (curing) and finishing stages S320, S330 and S340 are the same as those of the first and second embodiments, and thus repetitive descriptions thereof will be avoided.

According to the fourth embodiment, the tungsten sheet manufactured using the tungsten powder and having flexibility and restorability has the rate of shielding the gamma rays among the radioactive rays much better than that of the conventional radioactive ray shield sheet mainly using lead. Also, lead is heavy metal that is harmful to a human's health and body and pollutes environment while being used, and is fatal occasionally. Also, the product made of lead pollutes the environment when it is discarded. For example, lead or the like heavy metal may cause cancer or disease, be toxic, and bring a cranial nerve or intestine injury. Accordingly, the tungsten sheet according to an embodiment can enhance performance while eliminating negative effects from the conventional product made of lead

According to the fourth embodiment, on the contrary to lead, the tungsten sheet containing the tungsten powder and having flexibility and restorability, and the clothes made of the same is not harmful to a human body and safely shields the human body from the radioactive rays.

In the meantime, typical manufacture of the tungsten plate or sheet is performed at high temperature, e.g., thousands of degrees and requires complicated and expensive equipment. However, according to this embodiment, it is possible to simply and conveniently manufacture the tungsten sheet having high density as well as flexibility and restorability, so that it can be economically feasible. In the foregoing embodiment, such a tungsten sheet is used to shield the gamma ray, among various radioactive rays, but not limited thereto. Alternatively, the tungsten sheet may be variously employed for medicine, industry, etc. A mixing ratio, a manufacturing method, etc. of the tungsten powder may be changed for various purposes.

According to an embodiment, a radioactive ray shield or absorption sheet is excellent in flexible and restorable properties, and wearable when it is made as clothes.

Also, a radioactive ray shield or absorption sheet is improved in safety since there is no seam, hole, or etc.

Further, a radioactive ray shield or absorption sheet, is free from poisoning and thus improved in safety because lead powder, boron powder or tungsten powder is not friable and does not fall.

Further, a radioactive ray shield or absorption sheet is adjustable in content of shielding substance, strength, thickness, etc. corresponding to the amount of radioactive rays, and enhanced in a range of applications since it can be variously applied to clothes, a curtain, a protective wall, etc.

Further, a radioactive ray shield or absorption sheet is easily wearable like a general working jacket since it is opened frontward clothes made of the same and a manufacturing method thereof.

Further, a radioactive ray shield or absorption sheet does not pollute environment when it is discarded.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

1. A radioactive shield sheet manufactured to have a sheet shape by mixing powdered lead with an additive compound, and having flexibility and restorability.

2. The radioactive shield sheet according to claim 1, wherein the compound comprises an ester high molecular compound of an isocyanate group.

3. The radioactive shield sheet according to claim 2, wherein a content of the powdered lead is equal to or higher than 95 wt %, and the compound comprises an additive allowing the powdered lead and the high molecular compound to be bonded to each other and molded at high pressure to have high density.

4. Radioactive shield clothes comprising the radioactive shield sheet according to claim 1.

5. A method of manufacturing a radioactive shield sheet and radioactive shield clothes, the method comprising:
mixing powdered lead and a compound; and
molding the mixture at high pressure to have a sheet shape with high density.

6. The method according to claim 5, wherein
the compound comprises an ester high molecular compound of an isocyanate group
a content of the powdered lead is equal to or higher than 95 wt %.

7. A neutron radioactive absorption sheet manufactured to have a sheet shape by mixing powdered boron carbide with an additive compound, and having flexibility and restorability.

8. The neutron radioactive shield sheet according to claim 7, wherein the compound comprises an ester high molecular compound of an isocyanate group.

9. The neutron radioactive shield sheet according to claim 8, wherein a content of the powdered lead is within a range of 55˜60 wt %, and the compound comprises an additive allowing the powdered boron carbide and the high molecular compound to be bonded to each other and molded at high pressure to have high density.

10. A tungsten sheet manufactured to have a sheet shape by mixing powdered tungsten with an additive compound, and having flexibility and restorability.

11. The tungsten sheet according to claim 10, wherein the compound comprises an ester high molecular compound of an isocyanate group.

12. The tungsten sheet according to claim 8, wherein a content of the powdered tungsten is within a range of 80˜95 wt %, the tungsten sheet additionally comprises metal powder having high density, and the compound comprises an additive allowing the tungsten powder and the highly dense metal powder, which is within a range of 97˜98 wt %, to be bonded to each other and molded at high pressure to have high density.

13. Clothes comprising the tungsten sheet according to claim 10.

14. Radioactive shield clothes comprising the radioactive shield sheet according to claim 3.

15. Clothes comprising the tungsten sheet according to claim 12
